(19) United States
(12) Patent Application Publication
(10) Pub. No.: US 2025/0132696 A1
(43) Pub. Date: Apr. 24, 2025

(54) MAGNETIC POWER MACHINE AND METHOD OF USING THEREOF

(71) Applicants: Chien-Yu Hsu, Hualien County (TW); Po-Lin Hsu, Hualien County (TW); Yung-Hung Cheng, Hualien County (TW)

(72) Inventors: Chien-Yu Hsu, Hualien County (TW); Po-Lin Hsu, Hualien County (TW)

(21) Appl. No.: 18/382,392

(22) Filed: Oct. 20, 2023

(51) Int. Cl. H02N 11/00

(52) U.S. Cl. CPC H02N 11/008

(57) ABSTRACT

The present invention provides a magnetic power machine comprising a path portion, a rotor portion and a stator portion, wherein a rolling path is provided around the path portion; the rotor portion is provided around and outside the path portion and capable of rotating, and has an output shaft on one end that outputs power; a plurality of movable rods are provided on the rotor portion; a force-receiving arm and a roller are respectively provided on a top and a bottom of each of the movable rods; the roller moves along the rolling path; the force-receiving arm unfolds or folds as the roller moves up or down on the rolling path; the stator portion is provided around and outside the rotor portion; a plurality of force-exerting arms are provided opposite to the force-receiving arms on an inner edge of the stator portion; a magnetic force-exerting unit of single-sheet N-S arrangement and a magnetic force-receiving unit of triple-sheet N-S arrangement are respectively provided on the force-exerting arm and the force-receiving arm such that the force-exerting arm deflects by an operating angle to push the magnetic force-receiving unit to drive the rotor portion to rotate; the stator portion is divided into at least two stator sections, and the stator sections are allowed to get close to the rotor portion or to separate and move away from the rotor portion.

### BACKGROUND OF THE INVENTION

### 1. Field of the Invention

The present invention belongs to a magnetic power machine, and in particular a magnetic power machine that reduces energy loss and improves working efficiency, especially for small and medium-sized run-of-the-river electric generators. During dry periods in summer or winter, the magnetic power machine of the present invention can assist such electric generator in improving working efficiency with multiple sets of magnetic power machines additionally arranged in parallel to perform alternated pushing to supplement low water storage.

### 2. Description of the Prior Art

Known power machines are mainly categorized into six types according to different energy sources: water, wind, fossil fuel, geothermal energy, nuclear fuel and electricity. Through the conversion of energy, these power machines are able to output power for various applications.

However, regardless of the type of the power machine structure, continuous supply of fuel or electricity has to be maintained during its operation. Therefore, even when no load is connected, a certain amount of energy is still consumed, which leads to waste imperceptibly. Additionally, the power machine cannot continue to operate if incidents such as insufficient energy supply, fuel exhaustion, or power outage occur during operation, resulting in operation interruption and losses.

The development of civilizations has witnessed mankind's increasing need for power, yet the energy available on the earth keeps dwindling. Therefore, it has become an important objective of this industry to seek ways to bring down energy loss and improve the working efficiency of power machines.

Given the disadvantages of the known art, research and development is carried out and improvements are made by the inventor according to Lenz's law, i.e. an extension of the law of conservation of energy with respect to the non-conservative force associated with electric induction and magnetic induction, and a magnetic power machine of the present invention is then successfully completed.

### SUMMARY OF THE INVENTION

To overcome the aforementioned disadvantages, one main objective of the present invention is to provide a magnetic power machine that can operate for a longer period of time each time it is pushed and output power for applications, allowing for less energy waste and lower operation cost.

Another objective of the present invention is to provide a magnetic power machine, which cuts down demand for fuel or electricity since it does not require continued energy input, and which can even be operated manually when necessary to mitigate the impact of unstable supply of fuel or electricity.

Yet another objective of the present invention is to provide a magnetic power machine with a robust structure designed to sustain longer periods of continued operation, allowing for lower maintenance cost and increased working effectiveness.

To achieve the objectives described above, the technical solution adopted by the present invention is to provide a magnetic power machine comprising a path portion, a rotor portion and a stator portion, wherein
a rolling path that undulates continuously is provided around the path portion, the rolling path forming equal numbers of top edges and bottom edges;
the rotor portion is provided around and outside the path portion and capable of rotating, wherein the rotor portion has an output shaft on one end that outputs power, movable rods as many as the top edges and the bottom edges are provided on the rotor portion at regular intervals, a force-receiving arm and a roller are respectively provided on a top and a bottom of each of the movable rods, the roller moves along the rolling path, the force-receiving arm unfolds or folds with respect to the movable rod of the rotor portion and the force-receiving arm as the roller moves up or down on the rolling path, and a reset spring is disposed between the movable rod and the rotor portion; and
the stator portion is provided around and outside the rotor portion, wherein force-exerting arms as many as the force-receiving arms are provided on an inner edge of the stator portion at regular intervals; a magnetic force-exerting unit of single-sheet N-S arrangement and a magnetic force-receiving unit of triple-sheet N-S arrangement are respectively provided on approaching end faces of the force-exerting arm and the force-receiving arm; the force-exerting arm deflects by an operating angle such that the magnetic force-exerting unit of the force-exerting arm is directed at a rotating direction of the rotor portion to push the magnetic force-receiving unit to drive the rotor portion to rotate; the force-receiving arm is capable of swinging on the rod at an angle to keep the magnetic force-receiving unit directly facing the magnetic force-exerting unit to obtain an optimal thrust force; and the stator portion is divided into at least two stator sections, and the stator sections are allowed to get close to the rotor portion or to separate and move away from the rotor portion.

When using the magnetic power machine, the starting motor is started to provide the rotor portion with an initial velocity, and the stator sections are driven to get close to the rotor portion, magnetic repulsion between the magnetic force-exerting unit and the magnetic force-receiving unit is utilized to push the rotor portion to rotate, and then power is output for a load by virtue of the output shaft; and when the rotor portion operates for a period of time and its rotating speed and power output drop, the movable motor is restarted, the stator sections unfold and fold again so that the rotor portion can continue to output power. Since power production can last for a period of time each time the stator sections are driven, continued input of energy, or fuel, or electricity is not required, which results in higher overall efficiency compared to known power machines.

### BRIEF DESCRIPTION OF THE DRAWINGS

FIG. 1 is a planar structure view of a magnetic power machine of the present invention;

FIG. 2a is a front structure view of a lower half of a movable rod of the magnetic power machine;

FIG. 2b is a side structure view of the lower half of the movable rod;

FIG. 2c is a side structure view of a rotor portion of the magnetic power machine with a movable rod installation area;

FIG. 2d is a top structure view of the rotor portion with the movable rod installation area;

FIG. 3 is a schematic structure diagram relating to movement of the movable rod as the movable rod starts rolling along a bottom edge of a rolling path;

FIG. 4 is a schematic structure diagram relating to movement of the movable rod when the rolling path rises due to magnetic attraction;

FIG. 5 is a schematic structure diagram relating to movement of the movable rod when the movable rod reaches a top edge of the rolling path;

FIG. 6a is a front structure view of a force-receiving arm on a top of the movable rod;

FIG. 6b is a side structure view of the force-receiving arm;

FIG. 6c is a magnetic force line distribution diagram of a magnetic force-receiving unit with triple-sheet N-S arrangement provided on an end face of the force-receiving arm;

FIG. 6d is a magnetic force line distribution diagram illustrating magnetic attraction created when the magnetic force-receiving unit on the end face the force-receiving arm is directed towards a magnetic force-exerting unit on an end face of a stator portion of the magnetic power machine;

FIG. 6e is a magnetic force line distribution diagram illustrating polar repulsion as a result of the magnetic force-receiving unit directly facing the magnetic force-exerting unit, which creates a thrust force;

FIG. 7a is a front structure view of the force-receiving arm attached to a guide wheel;

FIG. 7b is a side structure view of the force-receiving arm attached to the guide wheel;

FIG. 8 is a schematic diagram of movement of the force-receiving arm attached to the guide wheel when the movable rod reaches a top edge;

FIG. 9 is a schematic diagram of movement of the magnetic power machine provided with three sets of rotor portions at the same time, where the three sets of movable rods are located on different positions of said matching rolling path and form a spiral sequence to achieve continuous rotation;

FIG. 10 is a side structure view of the magnetic power machine provided with more than three sets of said rotor portions at the same time;

FIG. 11 is a side structure view of the magnetic power machine driving the rotor portion with a starting motor;

FIG. 12a is a schematic structure view of the magnetic power machine with the rolling path provided on an end face of a path portion;

FIG. 12b is a schematic structure view of the roller provided next to the movable rod;

FIG. 13a is a scale drawing of structural variation of the movable rod attached to a bearing and positioned on the rotor portion;

FIG. 13b is a scale drawing of structural variation of the force-receiving arm on a top of the movable rod attached to the bearing;

FIG. 14a is a front schematic diagram of movement of the movable rod attached to the bearing when moving along the path portion, along with the force-receiving arm;

FIG. 14b is a side schematic diagram of movement of the movable rod attached to the bearing when rolling along the path portion, along with the force-receiving arm;

FIG. 15 is a schematic diagram of movement of the movable rod attached to the bearing, along with the path portion and the rotor portion relating to the movable rod; and

FIG. 16 is a schematic structure view of the movable rod attached to the bearing, with magnetic pole faces of the same magnetic pole provided both on surfaces of the guide wheel and of the guide rail.

### DESCRIPTION OF REFERENCE NUMBERS

100: Path portion
110: Rolling path
111: Top edge
112: Bottom edge
120: Position sensor
200: Rotor portion
210: Fixed shaft
220 [symbol] 220′: Movable rod
221 [symbol] 221′: Force-receiving arm
222 [symbol] 222′: Roller
223 [symbol] 223′: Reset spring
224 [symbol] 224′: Axle center
225 [symbol] 225′: Limit spring
226 [symbol] 226′: Lower positioning unit
227: Guide wheel
2271: Magnetic pole face
228′: Bearing
229 [symbol] 229′: Upper positioning unit
230: Magnetic force-receiving unit
231: Main magnetic element
232: Side magnetic element
240: Guide rail
2401: Magnetic pole face
250: Accommodating slot
260: Output shaft
270: Locating pin
300: Stator portion
300A [symbol] 300B: Stator section
310: Force-exerting arm
320: Magnetic force-exerting unit
330: Movable motor
340: Linear slide
400: Starting motor
410: Coupling portion
B1 [symbol] B2 [symbol] B3 . . . BN: Rotating wheel unit

### DETAILED DESCRIPTION OF THE PREFERRED EMBODIMENTS

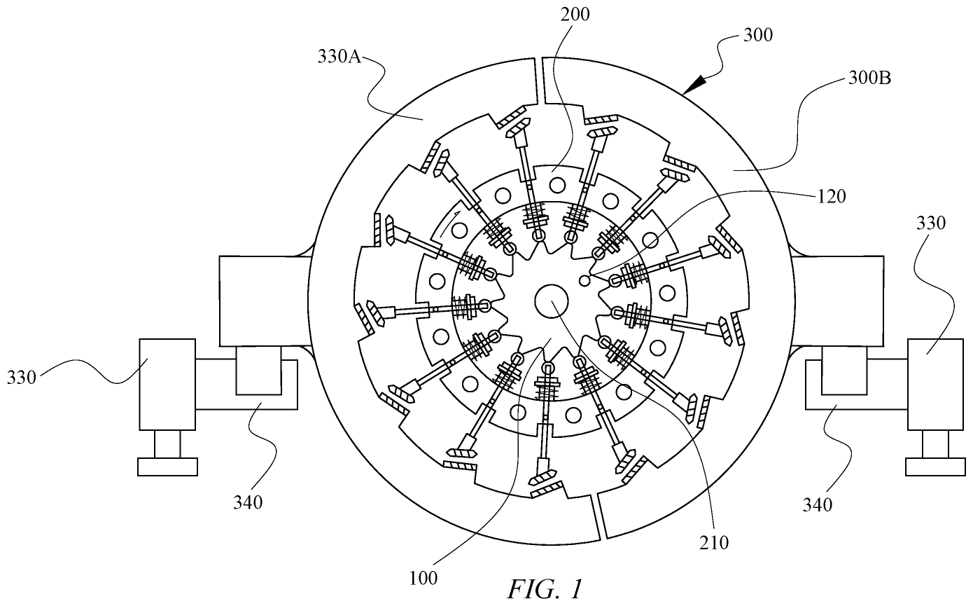

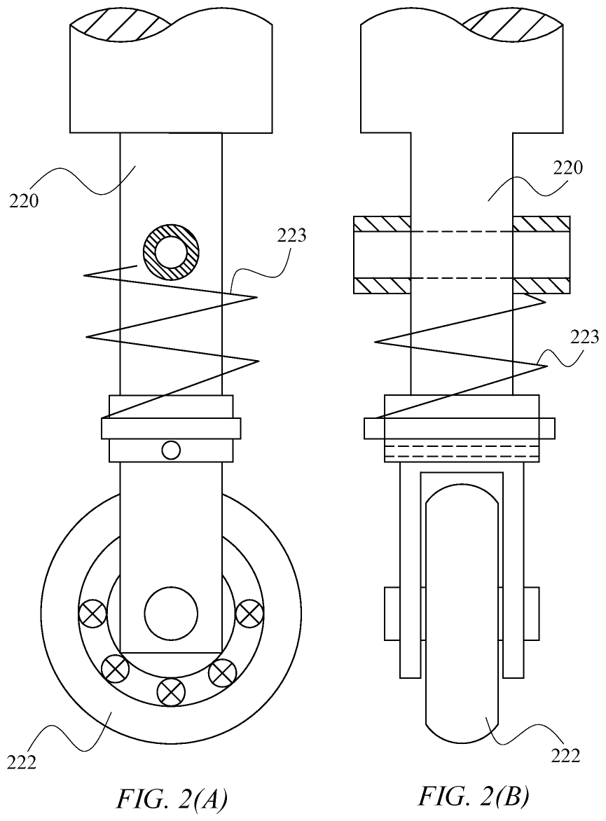

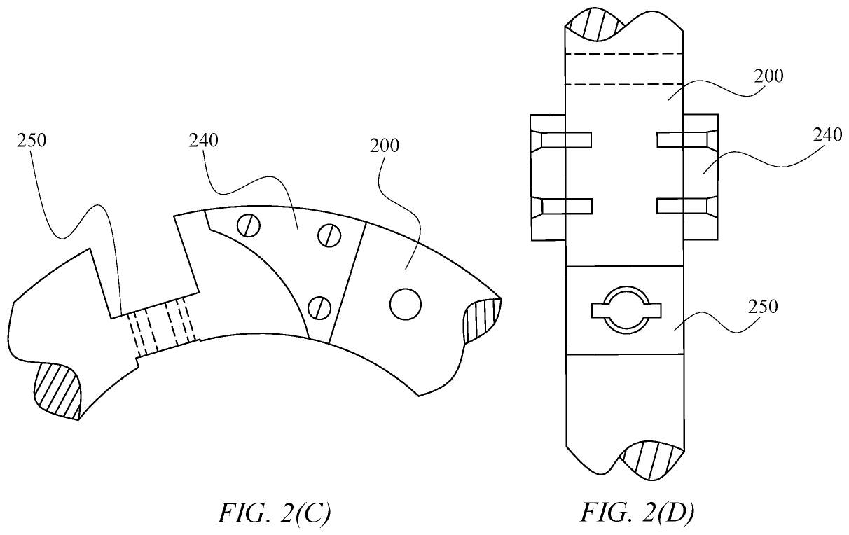

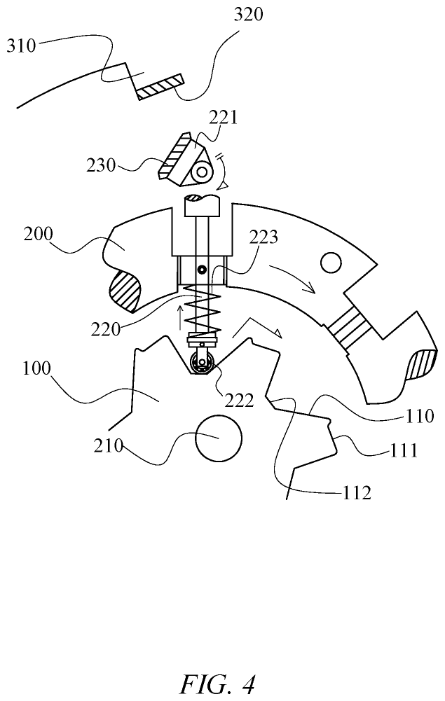

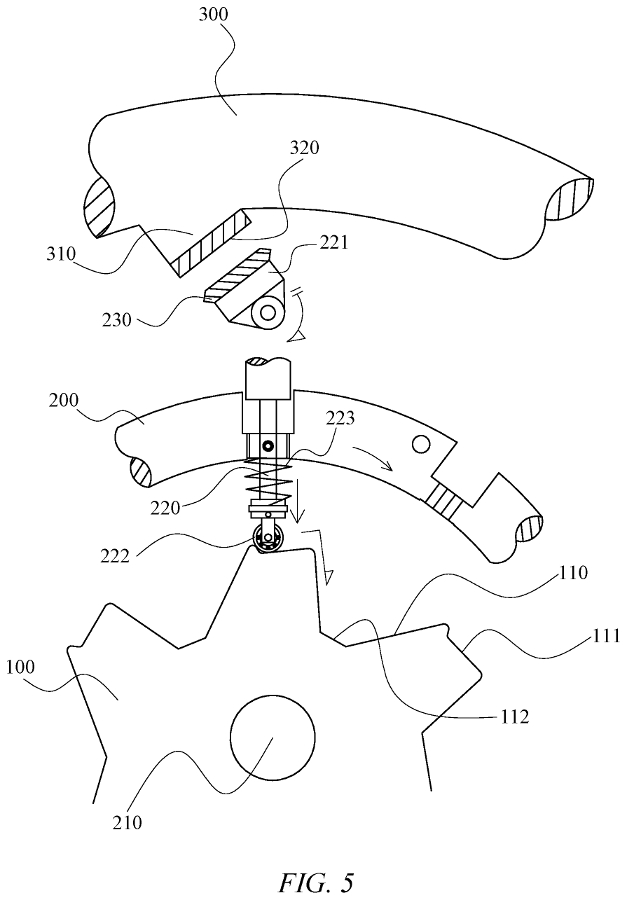

With reference to FIGS. 1, 2a-2d and 3-5, a magnetic power machine provided by the present invention is shown, including a path portion 100, a rotor portion 200 and a stator portion 300.

The path portion 100 is located on a fixed shaft 210 and does not rotate. The path portion is generally in a shape of a gear. A rolling path 110 that undulates continuously is provided around the path portion 100, such that the rolling path 110 forms equal numbers of top edges 111 and bottom edges 112.

The rotor portion 200 is a wheel rim which is provided around and outside the path portion 100 and is capable of rotating. A rotating center of the rotor portion 200 sleeves the fixed shaft 210 and allows the fixed shaft 210 to pass through a center position of the path portion 100, thereby maintaining concentric arrangement of the rotor portion 200 and the path portion 100. An output shaft 260 is driven at one end of the rotor portion 200 to output power. Movable rods 220 as many as the top edges 111 and the bottom edges 112 are provided on the rotor portion 200 at regular intervals. A force-receiving arm 221 and a roller 222 are respectively provided on a top and a bottom of the movable rod 220. The roller 222 moves along the rolling path 110. The force-receiving arm 221 is connected with and driven by the movable rod 220 as the roller 222 moves up or down on the rolling path 110, such that the force-receiving arm 221 is able to unfold or fold with respect to the rotor portion 200. A reset spring 223 is disposed between the movable rod 220 and the rotor portion 200.

The stator portion 300 is also generally in a shape of a wheel rim, and is provided around and outside the rotor portion 200 and arranged concentrically with the path portion 100 and the rotor portion 200. Force-exerting arms 310 as many as the force-receiving arms 221 are provided on an inner edge of the stator portion 300 at regular intervals. A magnetic force-exerting unit 320 of single-sheet N-S arrangement and a magnetic force-receiving unit 230 of triple-sheet N-S arrangement are respectively provided on the approaching end faces of the force-exerting arm 310 and the force-receiving arm 221. The magnetic force-exerting unit 320 and the magnetic force-receiving unit 230 are permanent magnets and rotate the rotor portion 200 as a result of polar repulsion. The force-exerting arm 310 directly facing the fixed shaft 210 deflects sideways by an operating angle such that the magnetic force-exerting unit 320 of the force-exerting arm 310 is directed at a rotating direction of the rotor portion 200. For example, the rotor portion 200 of this embodiment rotates clockwise, therefore, the force-exerting arm 310 deflects slightly counterclockwise to successfully push the magnetic force-receiving unit 230 to drive the rotor portion 200 to rotate. Additionally, the force-receiving arm 221 may swing on the movable rod 220 to keep the magnetic force-receiving unit 230 directly facing the magnetic force-exerting unit 320 to obtain an optimal thrust force, and the stator portion 300 is divided into at least two stator sections 300A and 300B, which are allowed to get close to the rotor portion 200 or to separate and move away from the rotor portion 200.

By means of the composition of the aforementioned units, the stator sections 300A and 300B of the stator portion 300 separate and move away from the rotor portion 200 prior to use without affecting each other; while in operation, the stator sections 300A and 300B are driven by a movable motor 330 to move on a linear slide 340 to get close to the rotor portion 200, that is, the rotor portion 200 is pushed to rotate as a result of mutual repulsion effect between the magnetic force-exerting unit 320 and the magnetic force-receiving unit 230, and then power is output to be used by a load by virtue of the output shaft 260. When the rotor portion 200 operates for a period of time and its rotating speed and power output drop, the movable motor 330 is restarted to allow the stator sections 300A and 300B to unfold and fold again so that the rotor portion 200 can continue to be driven to output power. Since power production can last for a period of time each time the stator sections 300A and 300B are driven, the movable motor 330 does not require continued electricity input, which results in higher overall efficiency compared to known power machines. Additionally, under special circumstances, the movable motor 330 may be disconnected from the stator portion 300, and the stator sections 300A and 300B may be controlled manually to ensure the stability of power output without interruption.

In order to prevent collision between the force-exerting arm 310 and the force-receiving arm 221 when the stator sections 300A and 300B get close to the rotor portion 200, a position sensor 120 is provided on a bottom edge 112 of the rolling path 110. The position sensor 120 is able to sense and make sure that the roller 222 has already entered the bottom edge 112, and at this time, the movable rod 220 remains at its lowest position and the force-receiving arm 221 folds inward before the stator sections 300A and 300B are driven to get close to and push the rotor portion 200 to operate. Additionally, the rotor portion 200 may stop operating under the condition that the position sensor 120 makes sure that the roller 222 has already entered the bottom edge 112 before the stator portion 300 is separated and moves away from the rotor portion 200. Using the position sensor 120 to sense and limit the movement of stator sections 300A and 300B can be easily achieved by those having ordinary skill in the art, and details are omitted here.

Further, the movable rod 220 is a linear rod passing through a preset accommodating slot 250 of the rotor portion 200, and the reset spring 223 is a telescopic spring. The reset spring 223 is disposed on the movable rod 220 in a sleeving manner, and two ends of the reset spring 223 are abutted between the movable rod 220 and the rotor portion 200. When the movable rod 220 rises from the bottom edge 112 to the top edge 111 of the rolling path 110, the reset spring 223 is compressed to exert a restoring force. And when the movable rod 220 drops from the top edge 111 to the bottom edge 112 of the rolling path 110, the reset spring 223 stretches due to restoring force and push the movable rod 220 to make sure that the roller 222 is pressed against the rolling path 110 around the path portion 100.

Additionally, the mutual repulsion effect between the magnetic force-exerting unit 320 and the magnetic force-receiving unit 230 can last a longer period of time, and the top edge 111 of the rolling path 110 is a long gentle slope path, thus the prolonged mutual repulsion adds to the thrust force exerted on the rotor portion 200.

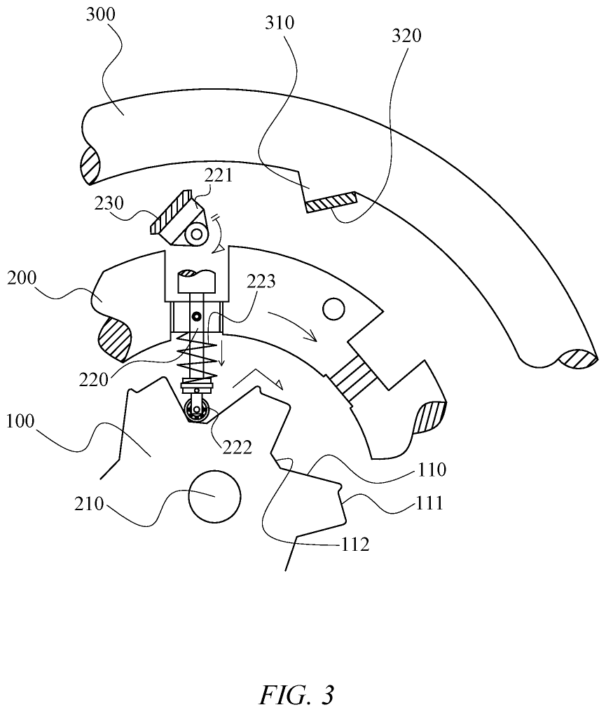

With reference to FIGS. 3-5, 6a and to 6b, as mentioned in the foregoing descriptions, the movable rod 220 is subjected to climbing resistance when the movable rod is ready to rise from the bottom edge 112 to the top edge 111 of the rolling path 110, during which the reset spring 223 is compressed. The movable rod is also subjected to the load of the magnetic force-receiving unit 230, the movable rod 220 and the roller 222. To avoid loss of power at this point, the force-receiving arm 221 of the present invention is positioned on the movable rod 220 through axle center 224 and capable of swinging, a limit spring 225, which is a torsional spring, is provided on the axle center 224, two ends of the limit spring 225 are abutted between the force-receiving arm 221 and the movable rod 220, a lower positioning unit 226 is provided on the movable rod 220, the lower positioning unit 226 is a bottom end in a groove provided on the movable rod 220, and allows the force-receiving arm 221 to swing under the action of the limit spring 225 and abut against the lower positioning unit 226. At this moment, the magnetic force-receiving unit 230 deflects opposite to a rotating direction of the rotor portion 200 and forms a parallel action angle with the magnetic force-exerting unit 320. In this way, when the force-receiving arm 221 gets close to the force-exerting arm 310 as the movable rod 220 rises, the side edge of the oblique magnetic force-receiving unit 230, affected by the distribution of magnetic force lines, will receive optimal magnetic attraction of the magnetic force-exerting unit 320 when parallel action angles directly face each other, helping the movable rod 220 reach the top edge 111 more effectively. At the same time, the force-receiving arm 221 unfolds with respect to the movable rod 220, and in an unfolding process of the force-receiving arm 221, the magnetic force-receiving unit 230 directly facing the magnetic force-exerting unit 320 is at a closest distance with the magnetic force-exerting unit 320 and obtains an optimal thrust force.

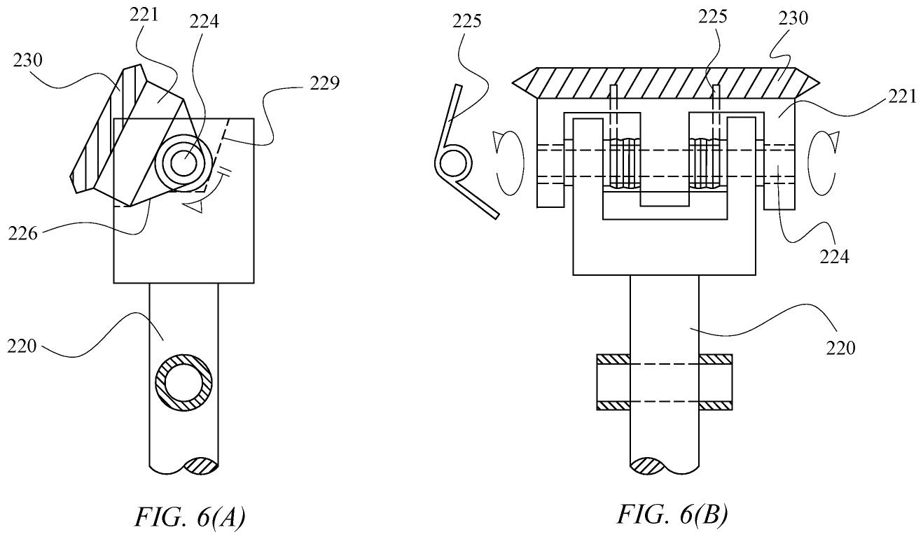

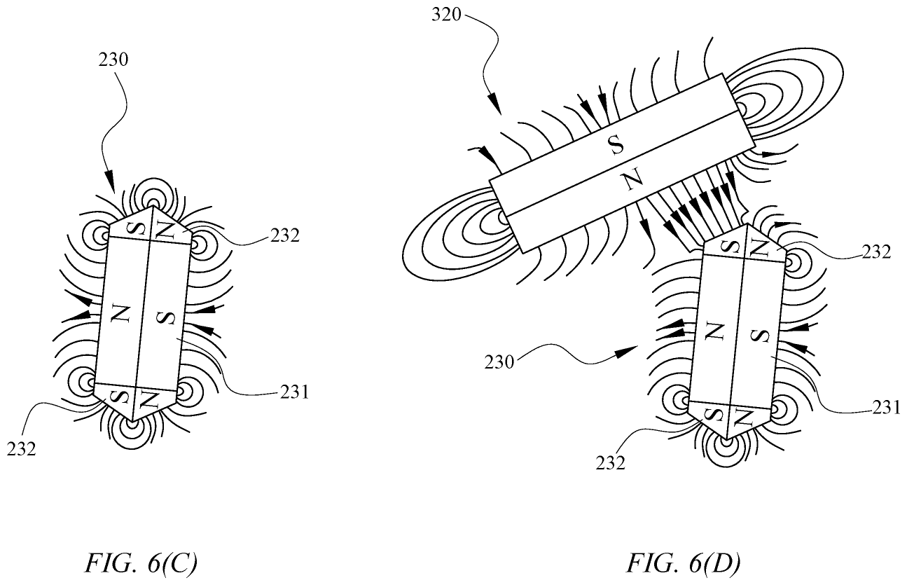

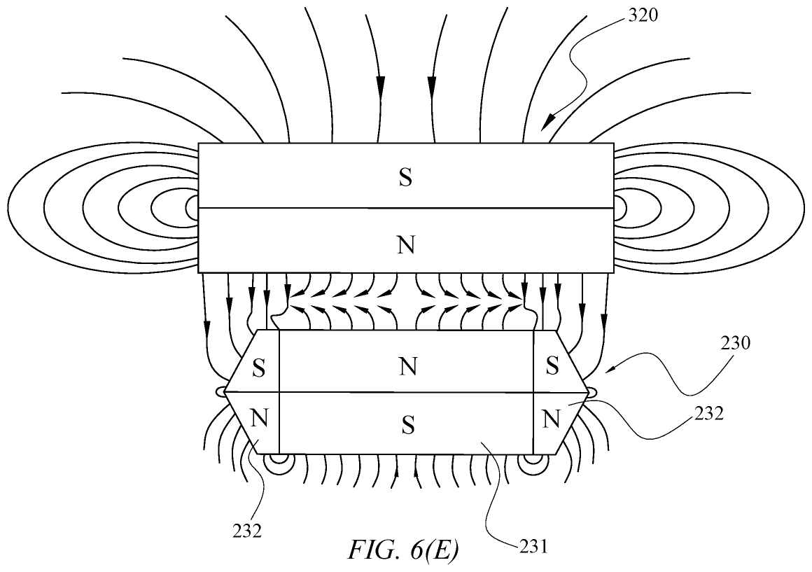

With reference to FIG. 6c to FIG. 6e, in order to enhance the interaction between the magnetic force-exerting unit 320 and the magnetic force-receiving unit 230, the magnetic force-exerting unit 320 is a single-sheet N-S magnet, and the magnetic force-receiving unit 230 is a magnet group of triple-sheet N-S arrangement formed by an elongate main magnetic element 231 in the middle and triangular side magnetic elements 232 connected to both sides of the main magnetic element 231. According to the principle of “like poles repel, unlike pole attract,” the main magnetic element 231 and each of the side magnetic elements 232 have opposite magnetic poles on the same end faces, the main magnetic element 231 has a greater length than the side magnetic elements 232 on both sides, and a sum of the length of the main magnetic element 231 and the lengths of the side magnetic elements 232 is less than the length of the magnetic force-exerting unit 320. This allows the side magnetic element 232, which completely enters the magnetic force line range of the magnetic force-exerting unit 320 when the magnetic force-receiving unit 230 gets close to the magnetic force-exerting unit 320, to be attracted, and allows the rotor portion to be successfully pushed and rotated as the magnetic repulsion exerted on the main magnetic element 231 is greater than the magnetic attraction exerted on the side magnetic element 232 when the magnetic force-receiving unit 230 directly faces the magnetic force-exerting unit 320.

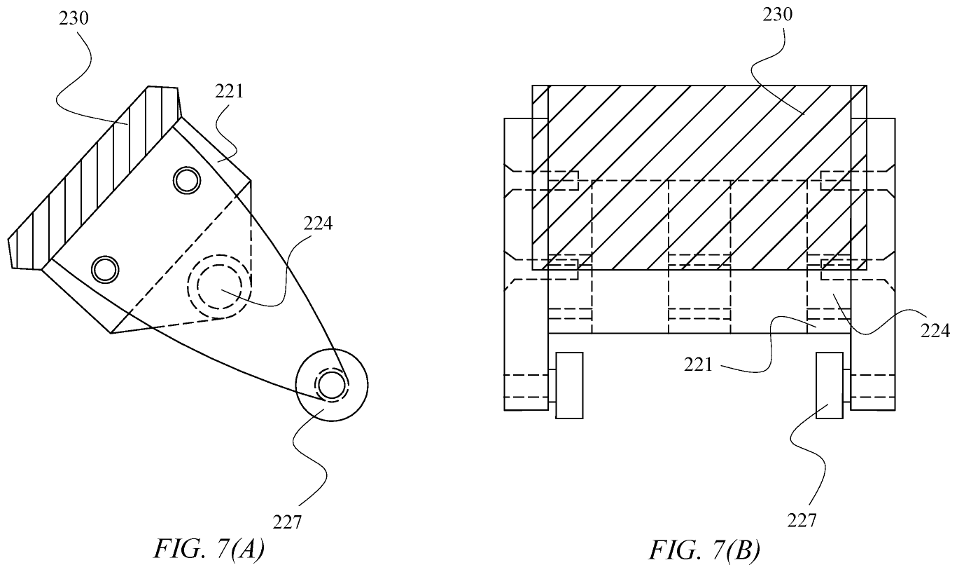

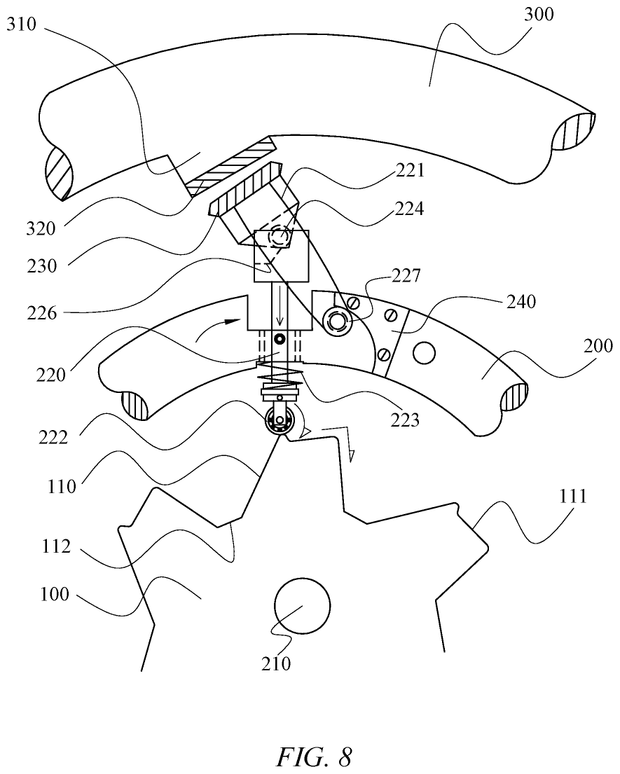

With reference to FIGS. 7a, 7b and 8, the force-receiving arm 221 is connected backwards to a guide wheel 227, a guide rail 240 is provided opposite to the rotor portion 200, and an upper positioning unit 229 is provided on an upper end of the groove. When the roller 222 of the movable rod 220 is pulled up by magnetic attraction and reaches the top edge 111 of the rolling path 110, the magnetic force-receiving unit 230 swings at an angle as a result of the guide wheel 227 contacting the guide rail 240, and the magnetic force-receiving unit 230 directly faces the magnetic force-exerting unit 320 as limited by the upper positioning unit 229, such that a position of the guide wheel 227 on the guide rail 240 varies as the movable rod 220 moves along the rolling path 110, and two types of operating action angles can be formed (i.e. when the force-receiving arm 221 unfolds or folds) by adjusting the swinging of the force-receiving arm 221, to keep the magnetic force-receiving unit 230 directly facing the magnetic force-exerting unit 320 to obtain an optimal thrust force.

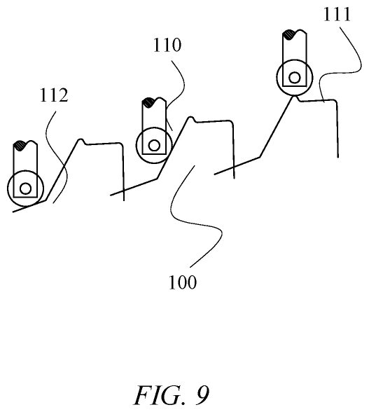

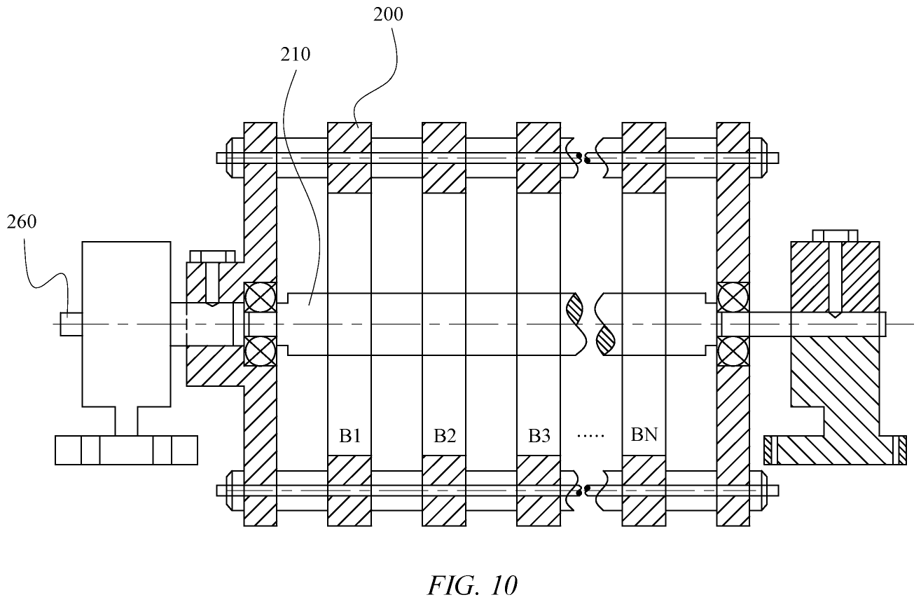

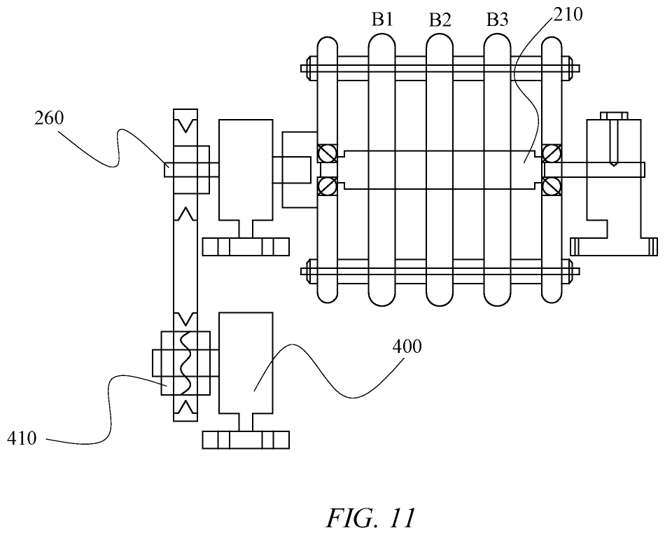

With reference to FIG. 9 to FIG. 11, at least three sets of said rotor portions 200 are provided at the same time, along with three sets of said path portions 100 and three sets of said stator portions 300 matching the three sets of said rotor portions 200. This embodiment merely take the rotor portion 200 as an example, and rotating wheel units B1, B2 and B3 are defined for convenience. The movable rods 220 of the rotor portions 200 provided on the three sets of rotating wheel units B1, B2 and B3 are located on the top edge 111 and the bottom edge 112 of the rolling path 110, and on a slope between the top edge 111 and the bottom edge 112 respectively and form a spiral sequence arrangement, which ensures at all times that the force-receiving arm 221 of at least one set of the movable rods 220 is subjected to a maximum thrust force as a result of getting close to the force-exerting arm 310. Of course, more parallel rotating wheel units B1, B2, B3 . . . . BN can be provided so as to allow for a smaller distance between any pair of the adjacent movable rods 220 on respective rolling paths 110 and to obtain a greater uniform thrust force. And each set of said rotor portions 200 is individually driven by said matching stator portions 300. Individual controlling of the portions can also be easily achieved by those having ordinary skill in the art, and details are omitted here.

Regardless of the number of the rotating wheel units B1, B2, B3 . . . BN, the output shaft 260 serving to output power is connected to a starting motor 400, a coupling portion 410 is provided at a connecting part between the output shaft and the starting motor, the starting motor 400 is utilized to provide the rotor portion 200 with an initial velocity before the stator portion 300 gets close to and pushes the rotor portion 200 to continuously rotate, and after the rotor portion 200 starts rotating, the coupling portion 410 is disconnected and a power source of the starting motor 400 is cut off, so that the power output of the output shaft 260 is more stable. To account for site arrangement, the output shaft 260 can be directly coupled or indirectly coupled through a gear, a chain, or a belt, etc. Such arrangements are common and details are omitted here.

Take three sets of said rotor portions 200 as an example. During actual operation, firstly, the roller 222 of the first set of said rotor portion 200 reaches the top edge 111 of the rolling path 110, the top edge 111 is slightly uphill, and a length of the top edge 111 matches an effective distance when the magnetic repulsion is converted to a thrust force as the magnetic force-exerting unit 320 directly faces the magnetic force-receiving unit 230.

Next, the second set of said rotor portion 200 is influenced by the thrust force of the first set of said rotor portion 200, and when the roller 222 of the second set of said rotor portion 200 rotating in tandem with the first set of said rotor portion 200 reaches an upper half of the slope of said matching rolling path 110, triangular N/S poles of the side magnetic element 232 of the triple-sheet N-S arrangement of the magnetic force-receiving unit 230 near one end of the stator portion 300 directly face an S/N pole face of the magnetic force-exerting unit 320, and an attraction force is exerted as the roller of the second rotor portion enters an effective distance of the attraction force, and pulls the magnetic force-receiving unit 230, the movable rod 220, the force-receiving arm 221, the roller 222 and the guide wheel 227, wherein the force-receiving arm 221 and the guide wheel 227 rise such that the magnetic force-receiving unit 230 swings at an angle as a result of the guide wheel 227 contacting the guide rail 240, and the magnetic attraction keeps pulling the movable rod 220 and the roller 222 until the roller stands on the top edge 111 of the rolling path 110, at this time magnetic repulsion is created as a result of the magnetic force-receiving unit 230 directly facing the force-exerting unit 320.

Next, the third set of said rotor portion 200 moves. Firstly, when the movable rod 220 and the roller 222 of the third set of said rotor portion 200 fall to the bottom edge 112 of the rolling path 110, the magnetic force-receiving unit 230 is disengaged from the magnetic force-exerting unit 320, and their magnetic field lines no longer cross; more importantly, magnetic hysteresis as a result of the magnetic field lines of every magnet on the magnetic force-receiving unit 230 and the magnetic force-exerting unit 320 forming closed loops is avoided, so that the rotor portion 200 is able to rotate for a relatively long period of time.

Secondly, when the magnetic force-receiving unit 230 falls to the bottom edge 112 of the rolling path 110, the magnetic force lines of the magnetic force-exerting unit 320 are cut off, and the magnetic force-receiving unit 230 returns to the lower positioning unit 226 with the aid of the limit spring 225.

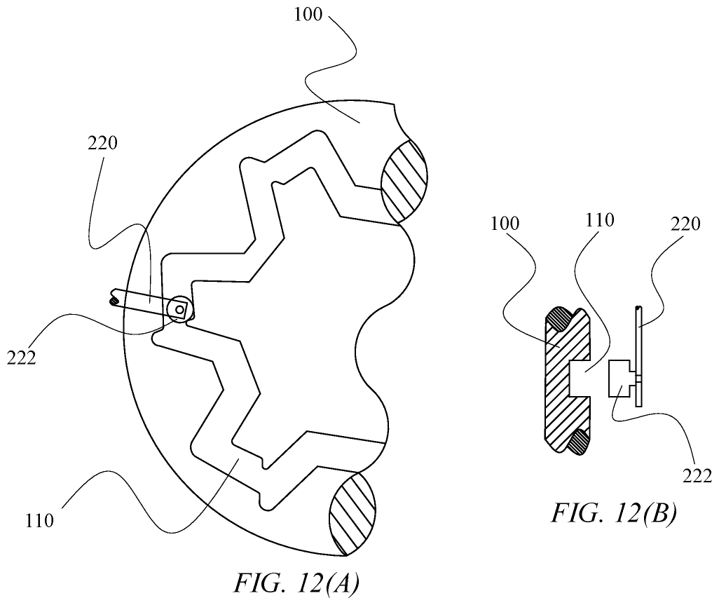

With reference to FIG. 12a and FIG. 12b, another design of a rolling path 110 is provided. The rolling path 110 extends inwardly from a periphery of the path portion 100, forming a slot way chiseled on the end face of the path portion 100. In order to fit the rolling path 110 in the form of this slot way, the roller 222 is provided next to the movable rod 220 such that the roller 222 is inserted into the rolling path 110 from a side of the path portion 100 and rolls.

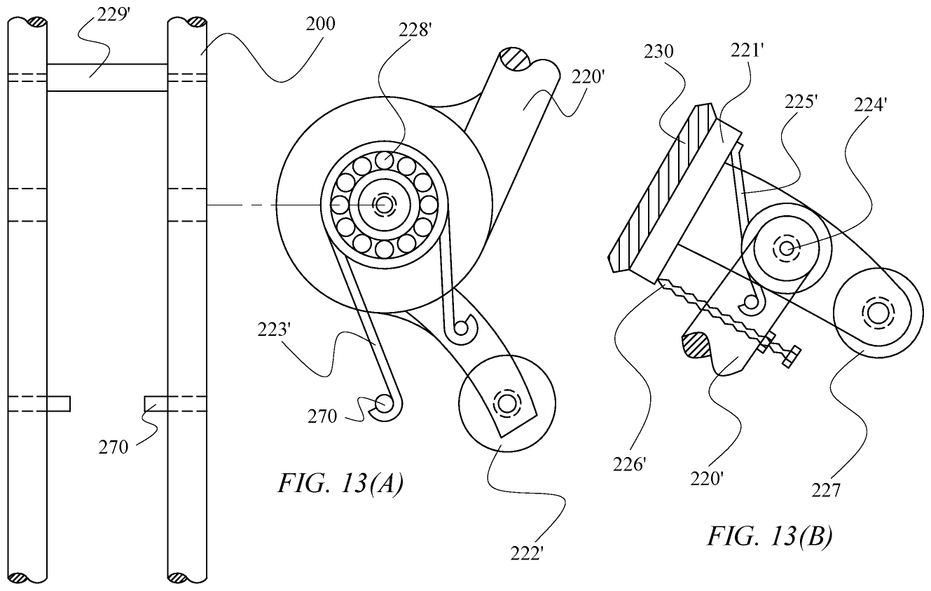

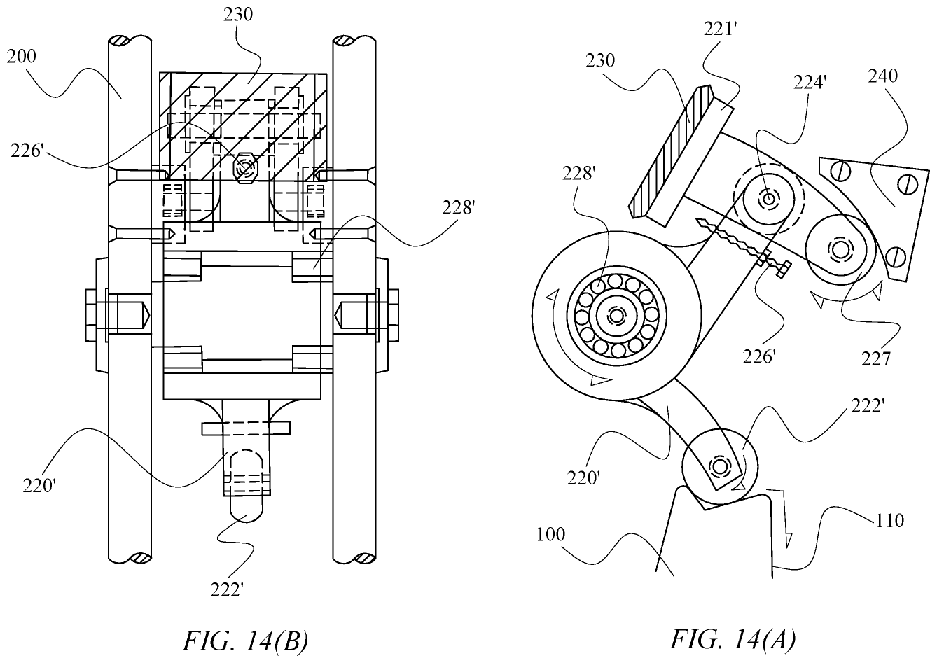

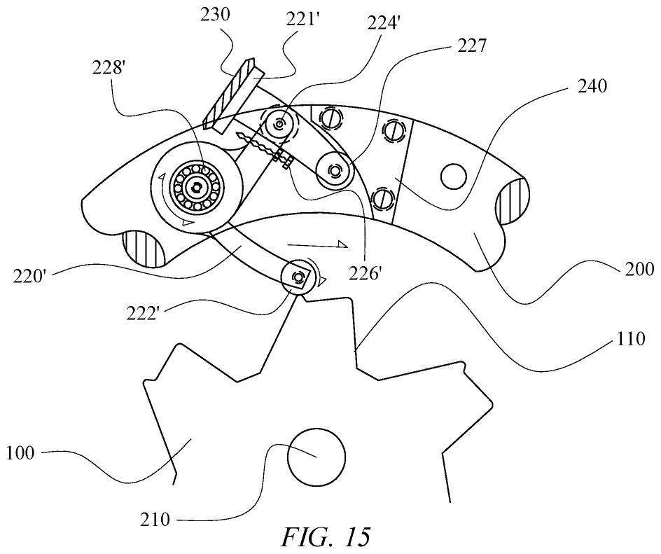

With reference to FIGS. 13a, 13b, 14a, 14b and 15, another design of a movable rod 220′ is provided. The movable rod is positioned on the rotor portion 200 through a bearing 228′, and a force-receiving arm 221′, a roller 222″, a reset spring 223′, an axle center 224′, a limit spring 225′, a lower positioning unit 226′ and a guide wheel 227 are also provided on the movable rod 220′. The bearing 228′ is a ball bearing. The reset spring 223′ is a torsional spring, the reset spring 223′ is provided on the bearing 228′, and two ends of the limit spring 223′ are abutted between the movable rod 220′ and a locating pin 270 of the rotor portion 200. The movable rod 220′ is bent at the two ends of the bearing 228′ to form a lower positioning angle that is adjusted as the force-receiving arm 221′ unfolds or folds. In this way, when the movable rod 220′ moves along the rolling path 110, the unfolding or folding of the force-receiving arm 221′ can be controlled through the bearing 228′ according to a position of the roller 222′, and a torsional force of the reset spring 223′ is used to make sure that the roller 222′ of the movable rod 220′ is pressed against the rolling path 100.

The force-receiving arm 221′ is also positioned on the movable rod 220′ through the axle center 224′ and capable of swinging. On the axle center 224″, the two ends of the limit spring 225′ are abutted between the force-receiving arm 221′ and the movable rod 220′. For the purpose of matching the design of the bent movable rod 220′, the lower positioning unit 226′ is a screw rod that passes through the movable rod 220′ and provides an action angle limiting the action of the force-receiving arm 221′. And the rotor portion 200 is additionally provided with the upper positioning unit 229′ that makes the magnetic force-receiving unit 230 directly face the magnetic force-exerting unit 320.

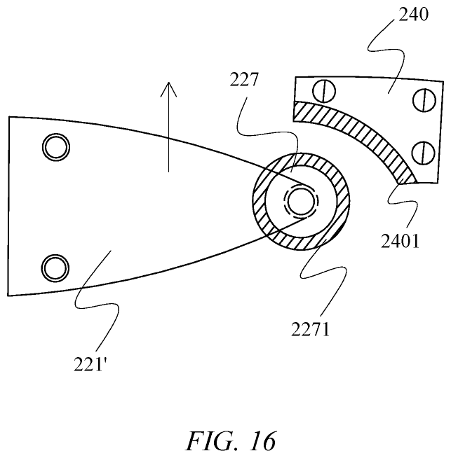

With reference to FIG. 16, another embodiment for the force-receiving arm 221′ is shown. Surfaces of the guide wheel 227 and the guide rail 240 have magnetic pole faces 2271, 2401 formed by magnets with the same magnetic pole, which prevents physical contact. And a swinging angle of the magnetic force-receiving unit 230 is increased due to magnetic repulsion. Avoiding physical contact is advantageous in that the component lives of the guide wheel 227 and the guide rail 240 are prolonged, noise caused by physical contact and shock are eliminated, and the magnetic force-receiving unit 230 is accelerated back to the lower positioning unit 226′ as it falls.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A path portion around which a rolling path that undulates continuously is provided, the rolling path forming equal numbers of top edges and bottom edges;
a rotor portion provided around and outside the path portion and capable of rotating, wherein the rotor portion has an output shaft on one end that outputs power, movable rods as many as the top edges and the bottom edges are provided on the rotor portion at regular intervals, a force-receiving arm and a roller are respectively provided on a top and a bottom of each of the movable rods, the roller moves along the rolling path, the force-receiving arm unfolds or folds with respect to the rotor portion as the roller moves up or down on the rolling path, and a reset spring is disposed between the movable rod and the rotor portion; and
a stator portion provided around and outside the rotor portion, wherein force-exerting arms as many as the force-receiving arms are provided on an inner edge of the stator portion at regular intervals; a magnetic force-exerting unit and a magnetic force-receiving unit are respectively provided on the approaching end faces of the force-exerting arm and the force-receiving arm; the magnetic force-exerting unit is a single-sheet N-S magnet and the magnetic force-receiving unit is a magnet group of triple-sheet N-S arrangement formed by an elongate main magnetic element in the middle and triangular side magnetic elements connected to both sides of the main magnetic element; the force-exerting arm deflects by an operating angle such that the magnetic force-exerting unit of the force-exerting arm is directed at a rotating direction of the rotor portion to push the magnetic force-receiving unit to drive the rotor portion to rotate; the force-receiving arm is capable of swinging on the movable rod to keep the magnetic force-receiving unit directly facing the magnetic force-exerting unit to obtain an optimal thrust force; and the stator portion is divided into at least two stator sections, and the stator sections are allowed to get close to the rotor portion or to separate and move away from the rotor portion.

2. The magnetic power machine of claim 1, wherein at least three sets of said rotor portions and said matching path portions and stator portions are provided at the same time such that the movable rods of the three sets of said rotor portions are respectively located on the top edge and the bottom edge of the rolling path, and on a slope between the top edge and the bottom edge of the rolling path and form a spiral sequence arrangement, which ensures at all times that the force-receiving arm of at least one set of the movable rods is subjected to a maximum thrust force as a result of getting close to the force-exerting arm.

3. The magnetic power machine of claim 2, wherein the force-receiving arm is positioned on the movable rod through an axle center; a limit spring is provided on the axle center; the limit spring is a torsional spring and two ends of the limit spring are abutted between the force-receiving arm and the movable rod; a lower positioning unit is provided on the movable rod, allowing the force-receiving arm to swing under the action of the limit spring 225 and abut against the lower positioning unit; and at this moment, N/S poles of the magnetic force-receiving unit directly face an S/N pole of the magnetic force-exerting unit, allowing the force-receiving arm to obtain optimal magnetic attraction when the force-receiving arm unfolds and gets close to a first half of the force-exerting arm, and allowing the movable rod to be pulled up to the top edge.

4. The magnetic power machine of claim 3, wherein the lower positioning unit is a bottom end in the groove provided on the movable rod that limits the magnetic force-receiving unit to a certain action angle; an upper positioning unit is provided on an upper end of the groove, and a guide rail is provided opposite to the rotor portion; when the roller of the movable rod is pulled up by magnetic attraction and reaches the top edge of the rolling path, the magnetic force-receiving unit swings at an angle as a result of the guide wheel contacting the guide rail, and directly faces the magnetic force-exerting unit as limited by the upper positioning unit; the force-receiving arm matching the guide rail is connected backwards to a guide wheel, such that a position of the guide wheel on the guide rail varies when the movable rod moves along the rolling path, and two types of operating action angles are formed by adjusting the swinging of the force-receiving arm.

5. The magnetic power machine of claim 4, wherein surfaces of the guide wheel and the guide rail have magnetic pole faces formed by magnets with the same magnetic pole, physical contact between the guide wheel and the guide rail is avoided to prolong lives of the guide wheel and the guide rail, and a swinging angle of the magnetic force-receiving unit is increased due to magnetic repulsion.

6. The magnetic power machine of claim 1, wherein the movable rod is a linear rod passing through the rotor portion, the reset spring is a telescopic spring, the reset spring sleeves the movable rod, two ends of the reset spring are abutted between the movable rod and the rotor portion, and the reset spring is utilized to make sure that the roller of the movable rod is pressed against the rolling path.

7. The magnetic power machine of claim 1, wherein the movable rod is positioned on the rotor portion through a bearing, the reset spring is a torsional spring, the reset spring is provided on the bearing, the two ends of the reset spring are abutted between the movable rod and a locating pin of the rotor portion, the movable rod is bent at two ends of the bearing to form a lower positioning angle, the lower positioning angle is adjusted according to the swinging angle of the force-receiving arm, and the reset spring is utilized to ensure that the roller of the movable rod is pressed against the rolling path.

8. The magnetic power machine of claim 1, wherein the rolling path is a slot way chiseled on an end face of the path portion, and the roller is provided next to the movable rod such that the roller is inserted into the rolling path from a side of the path portion and rolls.

9. The magnetic power machine of claim 1, wherein a position sensor is provided on the bottom edge and is required to make sure that the roller has already entered the bottom edge before the stator sections of the stator portion get close to and push the rotor portion to operate; and the rotor portion stops operating under the condition that the position sensor makes sure that the roller has already entered the bottom edge before the stator portion is separated and moves away from the rotor portion.

10. The magnetic power machine of claim 1, wherein the output shaft is connected to a starting motor, a coupling portion is provided at a connecting part between the output shaft and the starting motor, the starting motor is utilized to provide the rotor portion with an initial velocity before the stator portion gets close to and pushes the rotor portion, and after the rotor portion starts rotating, the coupling portion is disconnected and a power source of the starting motor is cut off.

11. A method of using a magnetic power machine, using a structure of the magnetic power machine of claim 4, characterized in that
the roller of the first set of said rotor portion reaches the top edge of the rolling path, the top edge is slightly uphill, a length of the top edge matches an effective distance when the magnetic repulsion is converted to a thrust force as the magnetic force-exerting unit directly faces the magnetic force-receiving unit;
next, the second set of said rotor portion is influenced by the thrust force of the first set of said rotor portion, and when the roller of the second set of said rotor portion rotating in tandem with the first set of said rotor portion reaches an upper half of the slope of said matching rolling path, triangular N/S poles of the side magnetic element of the triple-sheet N-S arrangement of the magnetic force-receiving unit near one end of the stator portion directly face an S/N pole face of the magnetic force-exerting unit, and an attraction force is exerted as the roller of the second rotor portion enters an effective distance of the attraction force, and pulls the magnetic force-receiving unit, the movable rod, the force-receiving arm, the roller and the guide wheel, wherein the force-receiving arm and the guide wheel rise such that the magnetic force-receiving unit swings at an angle as a result of the guide wheel contacting the guide rail, and magnetic attraction keeps pulling the movable rod and the roller until the roller stands on the top edge of the rolling path, at this time magnetic repulsion is created as a result of the magnetic force-receiving unit directly facing the force-exerting unit;
next, the third set of said rotor portion moves,
firstly, when the movable rod and the roller of the third set of said rotor portion fall to the bottom edge of the rolling path, the magnetic force-receiving unit is disengaged from the magnetic force-exerting unit, and their magnetic field lines do not cross, allowing the rotor portion to be able to rotate for a relatively long period of time;
secondly, when the magnetic force-receiving unit drops to the bottom edge of the rolling path, the magnetic force lines of the magnetic force-exerting unit are cut off, and the magnetic force-receiving unit returns to the lower positioning unit with the aid of the limit spring.
